(19) United States
(12) Patent Application Publication
(10) Pub. No.: US 2003/0234008 A1
(43) Pub. Date: Dec. 25, 2003

(54) Dual cooling intake system for an internal combustion engine

(76) Inventor: John Van Winkle, Walton, KY (US)

Correspondence Address: TAFT, STETTINIUS & HOLLISTER LLP, SUITE 1800, 425 WALNUT STREET, CINCINNATI, OH, 45202-3957, US

(21) Appl. No.: 10/223,575

(22) Filed: Aug. 19, 2002

Related U.S. Application Data
(63) Continuation-in-part of application No. 10/176,382, filed on Jun. 20, 2002.

(51) Int. Cl. F02B 33/00; F02B 29/04

(52) U.S. Cl. 123/559.1; 123/563; 60/599

(57) ABSTRACT

A fluid heat exchanger apparatus and associated method for cooling a fluid having an exhaust component associated with an internal combustion engine, the apparatus including: at least one thermoelectric device, concurrently absorbing thermal energy on a cool side and dissipating thermal energy on a warm side; a cool fluid conduit containing a cool fluid within a first closed loop, the cool fluid being in thermal communication with the cool side of at least the one thermoelectric device; and, a warm fluid conduit containing a warm fluid within a second closed loop, the warm fluid being in thermal communication with the warm side of at least the one thermoelectric device; where the cool fluid conduit is positioned to be in thermal communication with an internal combustion engine fluid stream having an exhaust component, thereby cooling the internal combustion engine fluid stream having the exhaust component.

### CROSS REFERENCE TO RELATED APPLICATIONS

The present application is a continuation-in-part of U.S. patent application Ser. No. 10/176,382, entitled, “FLUID COOLING APPARATUS FOR A COMBUSTION SYSTEM”, filed Jun. 20, 2002, and a continuation-in-part of U.S. patent application Ser. No. 10/______(Docket No. VA074-GN016), entitled, “DOUBLE CLOSED LOOP THERMOELECTRIC HEAT EXCHANGER”, filed Aug. 8, 2002.

### BACKGROUND

1. Field of the Invention

The invention relates to systems and methods of cooling fluids directed toward an internal combustion engine; and, in particular, to a method for cooling gases (such as air and/or exhaust) directed toward a combustion chamber of an internal combustion engine.

2. Description of Related Art

The cooling of fluids entering the combustion chamber of an internal combustion engine provides many advantages. Among these advantages are lowered degradation of components in thermal communication with the fluids and the ability to provide more oxygen for combustion. The latter advantage is brought about as the fluid is cooled, its density increases, thereby providing a higher concentration of oxygen per unit volume available as a combustion reactant.

The limiting nature of cooling the fluids entering the combustion chamber as one way of increasing the oxygen concentration resulted in research for an alternative through which an increase in the concentration of oxygen could be more easily achieved. A product of this research led to the development of turbochargers that utilize exhaust gases to compress intake fluids entering the combustion chamber, thereby increasing the oxygen concentration. However, whenever a gas is compressed within a fixed volume, the thermodynamic result is that the temperature of the gas is increased, and in the case of current state turbochargers, the intake fluid is substantially increased in temperature. This increased temperature results in a higher load being placed on the cooling system of the diesel engine, which is already substantial.

To achieve a lower temperature of the turbocharged fluid, intercoolers were developed that transferred thermal energy from the turbocharged fluid to the ambient air on an air-to-air convective system or on an air-to-liquid-to-air system. The intercooler was simply a second radiator. The problem arising in application to over-the-road trucks was where to place the intercooler. As the cross-section of the hood decreased for aerodynamic reasons, the cross-section available along the front grille was dominated by the conventional liquid radiator system, with the intercooler often placed behind the conventional liquid radiator. This placement provided obvious problems with regard to the thermal gradient available for thermal transfer from the air already passing through the conventional radiator.

With these problems still in existence, the Environmental Protection Agency (EPA) stepped in to announce sweeping changes in the level of Noₓ and particulate matter diesel engines may release. In an attempt to decrease Noₓ and particulate matter diesel engine manufacturers turned to exhaust gas recirculation (EGR). In this way, a portion of the exhaust gas is mixed with the intake fluid and directed to the combustion chamber, where the exhaust gas acts as an inert gas. This method has been shown to reduce Noₓ and particulate matter in the exhaust emitted to the environment. However, the detrimental effect on the engine has not been adequately tested to date.

One such detrimental effect on the engine appears to be the drastic increase in temperature associated with the already very hot exhaust gas coming back into the engine. Manufactures have turned to intercoolers in an attempt to cool the exhaust gas before it is mixed with the intake fluid downstream from the turbocharger. Current manufacturer methods for cooling the exhaust gases have not been able to cool the exhaust gas to temperature low enough such that the exhaust gas may be mixed with the intake fluid before being compressed by the turbocharger. Methods attempting this very piping arrangement resulted in premature failure of the turbocharger. Among other problems in the art are the limitations of the thermal gradient available for the intercoolers or conventional radiators, the increased temperature of the engine typically associated with EGR and the increased temperature of the oil associated with EGR.

### SUMMARY OF THE INVENTION

The invention relates to systems and methods of cooling fluids directed toward an internal combustion engine and, in particular, to the combustion chamber of an internal combustion engine. In an exemplary embodiment, the invention provides a cooling system and method for cooling intake fluids and exhaust fluids entering a combustion chamber of a diesel engines incorporating exhaust gas recirculation (EGR). In particular, the invention may provide for the cooling of the exhaust gas such that cooled exhaust gas may be incorporated with the intake fluid upstream from the turbocharger, thereby decreasing the thermal degradation of the turbocharger. In a more detailed exemplary embodiment, the cooled exhaust is added upstream from the turbocharger to the intake fluid and the compressed fluid downstream from the turbocharger is cooled before entering the combustion chamber.

The cooling systems and methods of the invention utilize thermoelectric devices having the ability to concurrently absorb thermal energy on a first surface and dissipate thermal energy on a second surface. The thermoelectric devices take advantage of the Peltier effect; a phenomenon which occurs whenever electrical current flows through two dissimilar conductors. Depending upon the flow of the current, the junction of two “P & N” doped semiconductor blocks will either absorb or dissipate thermal energy. The thermal energy is moved by the charge carriers in the direction of current flow throughout the circuit.

The invention utilizes this movement of thermal energy within the thermoelectric device to create thermal gradients between the target and a corresponding thermoelectric surface surface. If the target is a fluid, such as exhaust gas to be cooled, the temperature of the exhaust gas and the temperature of the cooler surface of the thermoelectric device are the points of reference for determining the thermal energy gradient. So long as the mean temperature of the cooler surface is less than that of the target, thermal energy will be drawn from the target and absorbed by the cooler surface, thereby cooling the target. In some applications in which the target is a fluid, it may not desired for the thermoelectric device to come into direct contact with the target; only thermal communication is necessary for thermal energy transfer. As such, the fluid targets may be contained in a reservoir, a conduit or a pump.

It is a first aspect of the invention to provide a fluid heat exchanger apparatus for cooling a fluid having an exhaust component associated with an internal combustion engine, the apparatus comprising: at least one thermoelectric device, concurrently absorbing thermal energy on a cool side and dissipating thermal energy on a warm side; a cool fluid conduit containing a cool fluid within a first closed loop, the cool fluid being in thermal communication with the cool side of at least the one thermoelectric device; and, a warm fluid conduit containing a warm fluid within a second closed loop, the warm fluid being in thermal communication with the warm side of at least the one thermoelectric device; wherein the cool fluid conduit is positioned to be in thermal communication with an internal combustion engine fluid stream having an exhaust component, thereby cooling the internal combustion engine fluid stream having the exhaust component.

It is a second aspect of the invention to provide a fluid heat exchanger apparatus for cooling a fluid having an exhaust component associated with an internal combustion engine, the apparatus comprising: at least one thermoelectric device, concurrently absorbing thermal energy on a first surface and dissipating thermal energy on a second surface; a closed cool fluid conduit having a cool fluid flowing therein with at least a portion of the cool fluid being in thermal communication with the first surface of the at least one thermoelectric device; and, an internal combustion conduit having a fluid stream flowing therein with an exhaust component; wherein the fluid stream flowing within the internal combustion conduit comes into thermal communication with the cool fluid, thereby cooling the fluid stream.

It is a third aspect of the invention to provide a fluid heat exchanger apparatus for cooling a fluid having an exhaust component associated with an internal combustion engine, the apparatus comprising: at least two thermoelectric devices, each thermoelectric device concurrently absorbing thermal energy on a first surface and dissipating thermal energy on a second surface; a first closed cool fluid conduit having a first cool fluid flowing therein with at least a portion of the cool fluid being in thermal communication with the first surface of at least a first thermoelectric device; a second closed cool fluid conduit having a second cool fluid flowing therein with at least a portion of the second cool fluid being in thermal communication with the first surface of at least a second thermoelectric device; and, an internal combustion conduit having a fluid stream flowing therein with an exhaust component; wherein the fluid stream flowing within the internal combustion conduit comes into thermal communication with the first cool fluid and the second cool fluid, thereby cooling the fluid stream.

It is a fourth aspect of the invention to provide a fluid heat exchanger apparatus for cooling a fluid having an exhaust component associated with an internal combustion engine, the apparatus comprising: at least one thermoelectric device concurrently absorbing thermal energy on a first surface and dissipating thermal energy on a second surface; a closed cool fluid conduit having a cool fluid flowing therein with at least a portion of the cool fluid being in thermal communication with the first surface of the at least one thermoelectric device; a closed warm fluid conduit having a warm fluid flowing therein with at least a portion of the warm fluid being in thermal communication with the second surface of the at least one thermoelectric device; a first radiator in fluid communication with the closed cool fluid conduit; a second radiator in fluid communication with the closed cool fluid conduit; a third radiator in fluid communication with the closed warm fluid conduit; a first internal combustion conduit section in fluid communication with the first radiator and having a first fluid stream with an exhaust component flowing therein; a second internal combustion conduit section in fluid communication with the second radiator and having a second fluid stream with the exhaust component flowing therein; a warm fluid pump directing the warm fluid throughout the closed warm fluid conduit; and, a cool fluid pump directing the cool fluid throughout the closed cool fluid conduit; wherein the cool fluid flowing within the first radiator comes into thermal communication with the first fluid stream, thereby cooling the first fluid stream, and the cool fluid flowing through the second radiator comes into thermal communication with the second fluid stream, thereby cooling the second fluid stream.

It is a fifth aspect of the invention to provide a fluid heat exchanger apparatus for cooling a fluid having an exhaust component associated with an internal combustion engine, the apparatus comprising: at least a first and a second thermoelectric device, each thermoelectric device concurrently absorbing thermal energy on a first surface and dissipating thermal energy on a second surface; a first closed cool fluid conduit having a first cool fluid flowing therein with at least a portion of the cool fluid being in thermal communication with the first surface of the at least first thermoelectric device; a second closed cool fluid conduit having a second cool fluid flowing therein with at least a portion of the second cool fluid being in thermal communication with the first surface of the at least second thermoelectric device; a first closed warm fluid conduit having a first warm fluid flowing therein with at least a portion of the first warm fluid being in thermal communication with the second surface of the at least first thermoelectric device, a second closed warm fluid conduit having a second warm fluid flowing therein with at least a portion of the second warm fluid being in thermal communication with the second surface of the at least second thermoelectric device; a first radiator in fluid communication with the first closed cool fluid conduit; a second radiator in fluid communication with the second closed cool fluid conduit; a first radiator in fluid communication with the first closed warm fluid conduit; a second radiator in fluid communication with the second closed cool fluid conduit; a first cool fluid pump directing the first cool fluid throughout the first closed cool fluid conduit; a second cool fluid pump directing the second cool fluid throughout the second closed cool fluid conduit; a first warm fluid pump directing the first warm fluid throughout the first closed warm fluid conduit; and, a second warm fluid pump directing the second warm fluid throughout the second closed warm fluid conduit; wherein the first cool fluid flowing within the first radiator comes into thermal communication with a first fluid stream having an exhaust component, thereby cooling the first fluid stream, and the second cool fluid flowing through the second radiator comes into thermal communication with a second fluid stream having the exhaust component, thereby cooling the second fluid stream.

It is a sixth aspect of the invention to provide a method of cooling a fluid having an exhaust component associated with an internal combustion engine, the method comprising the steps of: activating at least one thermoelectric device, concurrently absorbing thermal energy on a cool side and dissipating thermal energy on a warm side; orienting a cool fluid conduit containing a cool fluid within a first closed loop into thermal communication with the cool side of at least the one thermoelectric device; orienting a warm fluid conduit containing a warm fluid within a second closed loop into thermal communication with the warm side of at least the one thermoelectric device; and, directing an internal combustion engine fluid stream having an exhaust component into thermal communication with the cool fluid, thereby cooling the internal combustion engine fluid stream having the exhaust component.

It is a seventh aspect of the invention to provide a method of cooling a fluid having an exhaust component associated with an internal combustion engine, the method comprising the steps of: activating at least one thermoelectric device, concurrently absorbing thermal energy on a first surface and dissipating thermal energy on a second surface; orienting a closed cool fluid conduit having a cool fluid flowing therein, such that a portion of the cool fluid is in thermal communication with the first surface of the at least one thermoelectric device; and, orienting an internal combustion conduit having a fluid stream flowing therein with an exhaust component into thermal communication with the cool fluid; whereby the fluid stream is cooled by the cool fluid.

It is an eighth aspect of the invention to provide a method of cooling a fluid having an exhaust component associated with an internal combustion engine, the method comprising the steps of: activating at least two thermoelectric devices, each thermoelectric device concurrently absorbing thermal energy on a first surface and dissipating thermal energy on a second surface; orienting a first closed cool fluid conduit having a first cool fluid flowing therein, such that a portion of the first cool fluid is in thermal communication with the first surface of a first of the at least two thermoelectric devices; orienting a second closed cool fluid conduit having a second cool fluid flowing therein, such that a portion of the second cool fluid is in thermal communication with the first surface of a second of the at least two thermoelectric devices; and, orienting an internal combustion conduit having a fluid stream flowing therein with an exhaust component; whereby the fluid stream is cooled by the first cool fluid and the second cool fluid.

It is a ninth aspect of the invention to provide a method of cooling a fluid having an exhaust component associated with an internal combustion engine, the method comprising the steps of: activating at least one thermoelectric device concurrently absorbing thermal energy on a first surface and dissipating thermal energy on a second surface; orienting a closed cool fluid conduit having a cool fluid flowing therein with at least a portion of the cool fluid being in thermal communication with the first surface of the at least one thermoelectric device; orienting a closed warm fluid conduit having a warm fluid flowing therein with at least a portion of the warm fluid being in thermal communication with the second surface of the at least one thermoelectric device; orienting a first radiator into fluid communication with the closed cool fluid conduit; orienting a second radiator into fluid communication with the closed cool fluid conduit; orienting a third radiator into fluid communication with the closed warm fluid conduit; orienting a first internal combustion conduit section into fluid communication with the first radiator and having a first fluid stream with an exhaust component flowing therein; orienting a second internal combustion conduit section into fluid communication with the second radiator and having a second fluid stream with the exhaust component flowing therein; orienting a warm fluid pump into fluid communication with the closed warm fluid conduit; and, orienting a cool fluid pump into fluid communication with the closed cool fluid conduit; whereby the cool fluid flowing within the first radiator comes into thermal communication with the first fluid stream flowing, thereby cooling the first fluid stream, and the cool fluid flowing through the second radiator comes into thermal communication with the second fluid stream, thereby cooling the second fluid stream.

It is a tenth aspect of the invention to provide a method of cooling a fluid having an exhaust component associated with an internal combustion engine, the method comprising the steps of: activating at least a first and a second thermoelectric device, each thermoelectric device concurrently absorbing thermal energy on a first surface and dissipating thermal energy on a second surface; orienting a first closed cool fluid conduit having a first cool fluid flowing therein, a portion of the cool fluid being in thermal communication with the first surface of at least the first thermoelectric device; orienting a second closed cool fluid conduit having a second cool fluid flowing therein, a portion of the second cool fluid being in thermal communication with the first surface of at least the second thermoelectric device; orienting a first closed warm fluid conduit having a first warm fluid flowing therein, a portion of the first warm fluid being in thermal communication with the second surface of at least the first thermoelectric device; orienting a second closed warm fluid conduit having a second warm fluid flowing therein, a portion of the second warm fluid being in thermal communication with the second surface of at least the second thermoelectric device; orienting a first radiator into fluid communication with the first closed cool fluid conduit; orienting a second radiator into fluid communication with the second closed cool fluid conduit; orienting a first radiator into fluid communication with the first closed warm fluid conduit; orienting a second radiator into fluid communication with the second closed cool fluid conduit; orienting a first cool fluid pump into fluid communication with the first closed cool fluid conduit; orienting a second cool fluid pump into fluid communication with the second closed cool fluid conduit; orienting a first warm fluid pump into fluid communication the first closed warm fluid conduit; and, orienting a second warm fluid pump into fluid communication with the second closed warm fluid conduit; whereby the first cool fluid flowing within the first radiator comes into thermal communication with a first fluid stream having an exhaust component, thereby cooling the first fluid stream, and the second cool fluid flowing through the second radiator comes into thermal communication with a second fluid stream having the exhaust component, thereby cooling the second fluid stream.

It is an eleventh as aspect of the invention to provide an exhaust gas recirculation system for a vehicle comprising: an internal combustion engine having a gas intake and an exhaust outlet; a turbocharger having a gas intake and a pressurized gas outlet; a turbo fluid conduit providing fluid communication between the pressurized gas outlet of the turbocharger and the gas intake of the internal combustion engine; an exhaust recirculation conduit providing fluid communication between the exhaust outlet of the internal combustion engine and the gas intake of the turbocharger; and, a first heat exchanger generating a thermal gradient between (a) fluid flow in at least one of the turbo fluid conduit and the exhaust recirculation conduit and (b) at least one Peltier-effect thermoelectric device concurrently dissipating thermal energy on a warm surface thereof and absorbing thermal energy on a cool surface thereof.

It is a twelfth as aspect of the invention to provide an exhaust gas recirculation system for a vehicle comprising: an internal combustion engine having a gas intake and an exhaust outlet; a turbocharger having a gas intake and a pressurized gas outlet; a turbo fluid conduit providing fluid communication between the pressurized gas outlet of the turbocharger and the gas intake of the internal combustion engine; an exhaust recirculation conduit providing fluid communication between the exhaust outlet of the internal combustion engine and the gas intake of the turbocharger; a first heat exchanger generating a thermal gradient between fluid flow in the turbo fluid conduit and at least one Peltier-effect thermoelectric device concurrently dissipating thermal energy on a warm surface thereof and absorbing thermal energy on a cool surface thereof; and, a second heat exchanger generating a thermal gradient between fluid flow in the exhaust recirculation conduit and at least one Peltier-effect thermoelectric device concurrently dissipating thermal energy on a warm surface thereof and absorbing thermal energy on a cool surface thereof.

It is a thirteenth as aspect of the invention to provide a method of cooling an exhaust gas recirculation system for a vehicle comprising the steps of: orienting a turbo fluid conduit to provide fluid communication between a pressurized gas outlet of a turbocharger and a gas intake of an internal combustion engine; orienting an exhaust recirculation conduit to provide fluid communication between an exhaust outlet of the internal combustion engine and a gas intake of the turbocharger; and, orienting a first heat exchanger so as to generate a thermal gradient between fluid flow in at least one of the turbo fluid conduit and the exhaust recirculation conduit and at least one Peltier-effect thermoelectric device concurrently dissipating thermal energy on a warm surface thereof and absorbing thermal energy on a cool surface thereof.

It is a fourteenth as aspect of the invention to provide a method of cooling an exhaust gas recirculation system for a vehicle comprising the steps of: orienting a turbo fluid conduit so as to provide fluid communication between a pressurized gas outlet of a turbocharger and a gas intake of the internal combustion engine; orienting an exhaust recirculation conduit so as to provide fluid communication between an exhaust outlet of the internal combustion engine and a gas intake of the turbocharger; orienting a first heat exchanger so as to generate a thermal gradient between fluid flow in the turbo fluid conduit and at least one Peltier-effect thermoelectric device concurrently dissipating thermal energy on a warm surface thereof and absorbing thermal energy on a cool surface thereof; and, orienting a second heat exchanger so as to generate a thermal gradient between fluid flow in the exhaust recirculation conduit and at least one Peltier-effect thermoelectric device concurrently dissipating thermal energy on a warm surface thereof and absorbing thermal energy on a cool surface thereof.

### BRIEF DESCRIPTION OF THE DRAWINGS

FIG. 1 is a schematic of a first exemplary embodiment of the invention.

FIG. 2 is an exploded view of an exemplary thermoelectric heat exchanger in accordance with the invention.

FIG. 3 is a front view of an exemplary thermoelectric heat exchanger in accordance with the invention.

FIG. 4 is a rear view of an exemplary thermoelectric heat exchanger in accordance with the invention.

FIG. 5 is a schematic of an exemplary thermoelectric heat exchanger and associated elements in accordance with the invention.

FIG. 6 is a schematic of a second exemplary embodiment of the present invention.

FIG. 7 is a schematic of a third exemplary embodiment of the present invention

### DETAILED DESCRIPTION

It should be understood that the following detailed description of exemplary embodiments of the invention are exemplary in nature and shall not constitute limitations upon the invention. It is also to be understood that variations of the exemplary embodiments contemplated by one of ordinary skill in the art shall concurrently fall within the scope and spirit of the invention. Although certain aspects of the exemplary embodiments are shown in more detail, some features within the purview of one skilled in the art may have been omitted for the sake of clarity and brevity.

The invention relates to systems and methods of cooling fluids directed toward an internal combustion engine and, in particular, to a combustion chamber of an internal combustion engine. The invention utilizes commercially available thermoelectric devices, such as the CP 2-127-06L, from Melcor, of Trenton, N.J. (www.melcor.com). These thermoelectric devices provide concurrent thermal dissipation and thermal absorption when electric current is applied to the thermoelectric device, typically on opposing sides of the device. The principle behind this concurrent potential is referred to as the “Peltier effect” and is well known in that art. For purpose of reference only, the detailed description will refer to a cooler surface and a warmer surface of the thermoelectric device, however, it should be apparent to one of ordinary skill in the art that these designations are not set in stone, as the direction of the electric current is inverted, so are the accompanying designations.

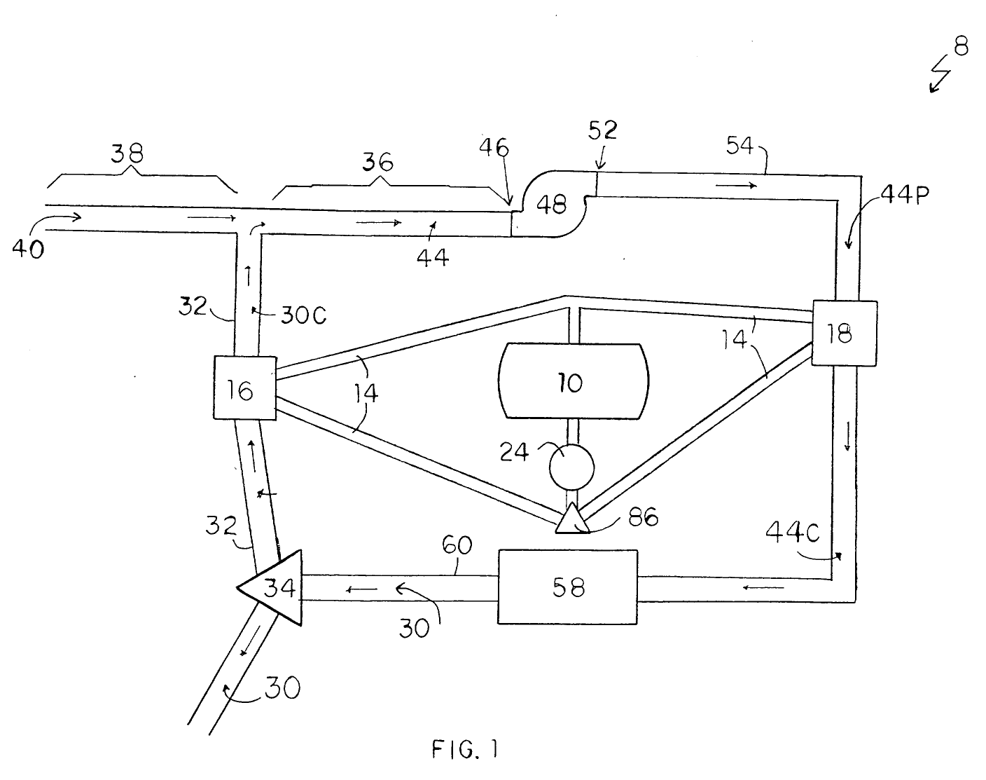

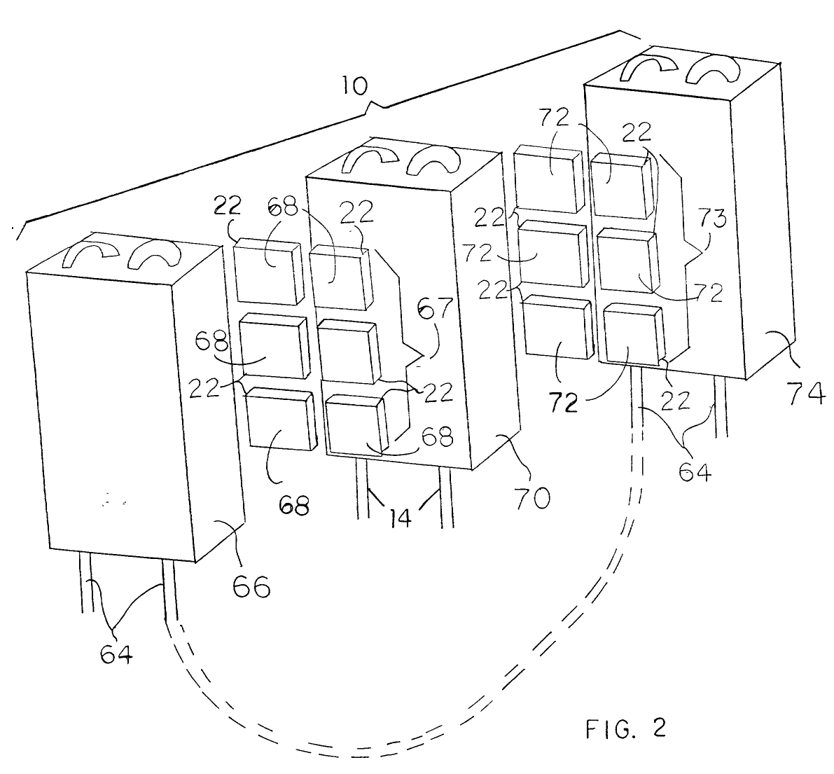

Referring to FIG. 1, a first exemplary embodiment of a dual cooler 8 is shown. A thermoelectric heat exchanger 10, shown in more detail in FIGS. 2-4, is in fluid communication with an aluminum exhaust radiator 16 and an aluminum intake mixture radiator 18 via an insulated copper cool fluid conduit 14. A cool fluid 20 flows through the thermoelectric heat exchanger 10, which potentially cools the cool fluid 20 to a temperature below that of the ambient environment. After the cool fluid 20 has come into thermal communication with the thermoelectric devices 22 (See FIG. 2) of the thermoelectric heat exchanger 10 and has thereafter exited the thermoelectric heat exchanger 10, a cool fluid pump 24 directs a portion of the cool fluid through the cool exhaust radiator 16, while the remainder of the cool fluid is directed through the cool intake mixture radiator 18.

As a portion of the engine exhaust 30 coming from the combustion chamber of an internal combustion engine 58 is directed into a recycle exhaust conduit 32 by a diverter 34 (may also be called an EGR valve; see, for example U.S. Pat. Nos. 6,378,509; 6,247,461; 6,168,134; 6,167,873), the diverted exhaust 30 comes into thermal communication with the cool fluid 20 flowing within the cool exhaust radiator 16. In this exemplary embodiment, the exhaust radiator 16 is placed in-line or in series with the recycle exhaust conduit 32. The thermal gradient between the relatively hot, diverted exhaust 30 and the relatively cold cool fluid 20 results in thermal energy being drawn from the exhaust 30 and absorbed by the cool fluid 20. The resulting thermal energy loss of the exhaust 30 provides a lower temperature, cool exhaust 30C entering an intake conduit 36.

The intake conduit 36 generally has two feeds. The first feed 38 of the intake conduit 36 provides ambient air 40 to the turbocharger inlet 46. The second feed 32 of the intake conduit, referred to previously as the recycle exhaust conduit 32 provides cooled exhaust 30C to the turbocharger inlet 46. As the mixture 44 of air 40 and cooled exhaust 30C are drawn into an inlet 46 of the turbocharger 48, the turbocharger air pump directs the mixture 44 through an outlet 52 and into the mixed fluid conduit 54 in a compressed state. As the volume of the mixed fluid conduit 54 is generally fixed, a pressure differential exists between the inlet 46 and the 52 outlet of the turbocharger 48. The pressurized mixture 44P on the outlet 52 side of the turbocharger exhibits an increase in temperature as opposed to the mixture 44 on the inlet 46 side of the turbocharger 48. These thermodynamic principles are known by those of ordinary skill and explanation is therefore omitted for purposes of brevity.

The relatively hot compressed mixture 44P comes into thermal communication with the cool fluid 20 within the cool intake mixture radiator 18. The cool intake mixture radiator 18 contains cool fluid 20 cycling to and from the thermoelectric heat exchanger 10. As the temperature of the compressed mixture 44P is greater than that of the cool fluid 20, a thermal gradient exists through which thermal energy is transferred from the compressed mixture 44P to the cool fluid 20. As the mixture 44 is cooled, the pressure exerted upon the mixture 44 is decreased accordingly. This cooled mixture 44C is then fed into a combustion chamber of an internal combustion engine 58, where a fuel is also fed into the combustion chamber. The resulting combustion of the fuel produces exhaust gas 30 that is directed out of the combustion chamber and into the exhaust conduit 60. The exhaust conduit 60 is in fluid communication with the diverter 34, thereby providing the feed of exhaust for the recycle exhaust conduit 32. All, or a majority, of the exhaust exiting the combustion chamber may be utilized to drive the turbocharger turbine, with the diverter 34 thereby being downstream from the turbocharger 48 with respect to the exhaust conduit 60 in such an application. In certain applications, the portion of the exhaust not entering the exhaust conduit 60 may be utilized to drive the turbine of the turbocharger 48.

As shown in FIGS. 2-4, the thermoelectric heat exchanger 10 is comprised of a first block of heat transfer material 66 in thermal communication with warmer surfaces 68 of the thermoelectric devices 22 in a first bank 67, a second block of heat transfer material 70 in thermal communication with cooler surfaces 72 of the thermoelectric devices 22 in the first bank 67 and in a second bank 73, and a third block of heat transfer material 74 in thermal communication with the warmer surfaces 68 of the thermoelectric devices 22 in the second bank 73.

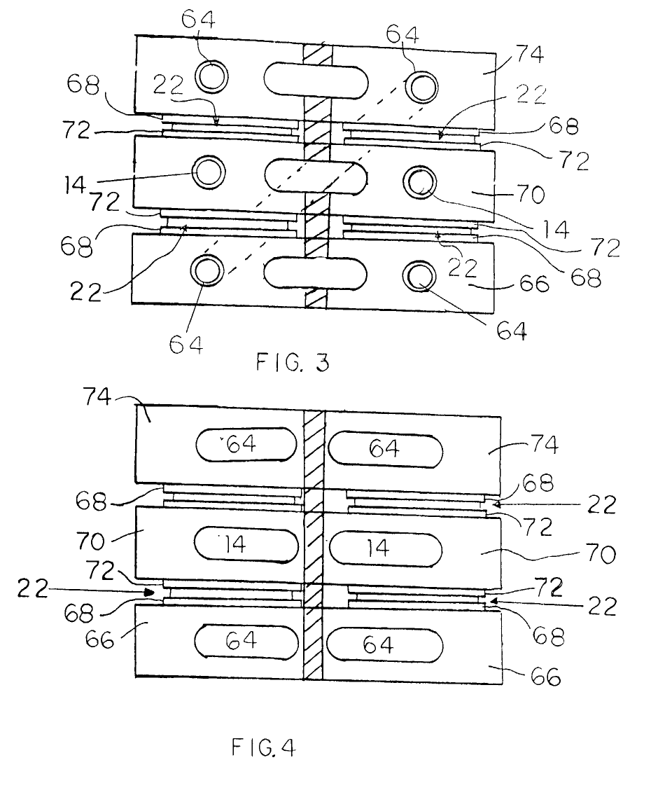

The first block and third block of heat transfer material 66, 74 sandwiches the second block of heat transfer material 70 therebetween. Additionally, the first bank 67 of thermoelectric devices is sandwiched between the first and second block 66, 70 of heat transfer material, while the second bank 73 of thermoelectric devices is sandwiched between the second and third blocks 70, 74 of heat transfer material. Both the first block and third block of heat transfer material 66, 74 provide throughput of the warm fluid 80 flowing through the closed loop of warm fluid conduit 64. This throughput may be achieved as shown in FIG. 3 by utilizing heat transfer blocks machined, molded or otherwise fabricated to allow throughput of the warm fluid conduit 64. In such a circumstance, the orientation between the respective blocks 66, 74 and the warm fluid conduit 64 is preferably such that maximum thermal communication between the warmer surfaces 68 of the thermoelectric devices 22 and the warm fluid 80 may be achieved. However, it is also within the scope of the invention to provide blocks of heat transfer material being machined, molded or otherwise fabricated to provide throughput of the warm fluid 80 without necessitating a separate warm fluid conduit 64. Such throughput might consist of a single serpentine path or a series of linear or nonlinear paths. It is also within the scope of the invention to eliminate the first block and third block of heat transfer material 66, 74 and mount the warm fluid conduit 64 to the warmer surfaces 68 of the thermoelectric devices 22. In such a variation, the warm fluid conduit 64 may be manufactured from aluminum and have a non-circular cross-section and provide for one or more channels of warm fluid 80 flow.

The second block of heat transfer material 70 provides throughput of the cool fluid conduit 14. The orientation between the second block of heat transfer material 70 and the cool fluid conduit 14 is preferably such that maximum thermal communication between the cooler surfaces 72 of the thermoelectric devices 22 and the cool fluid 20 may be achieved. However, it is also within the scope of the invention to provide a block of heat transfer material being machined, molded or otherwise fabricated to provide throughput of the cool fluid 20 without necessitating a separate cool fluid conduit 14. Such throughput might consist of a single serpentine path or a series of linear or nonlinear paths. It is also within the scope of the invention to eliminate the second heat transfer block 70 and mount the cool fluid conduit 14 to the cooler surfaces 70 of the thermoelectric devices 22. In such a variation, the cool fluid conduit 14 may have a non-circular cross-section and provide for one or more channels of cool fluid 20 flow.

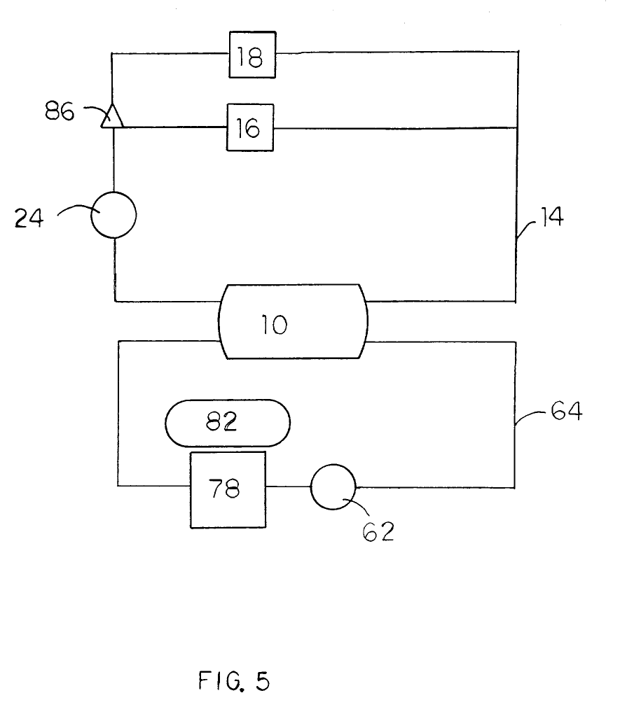

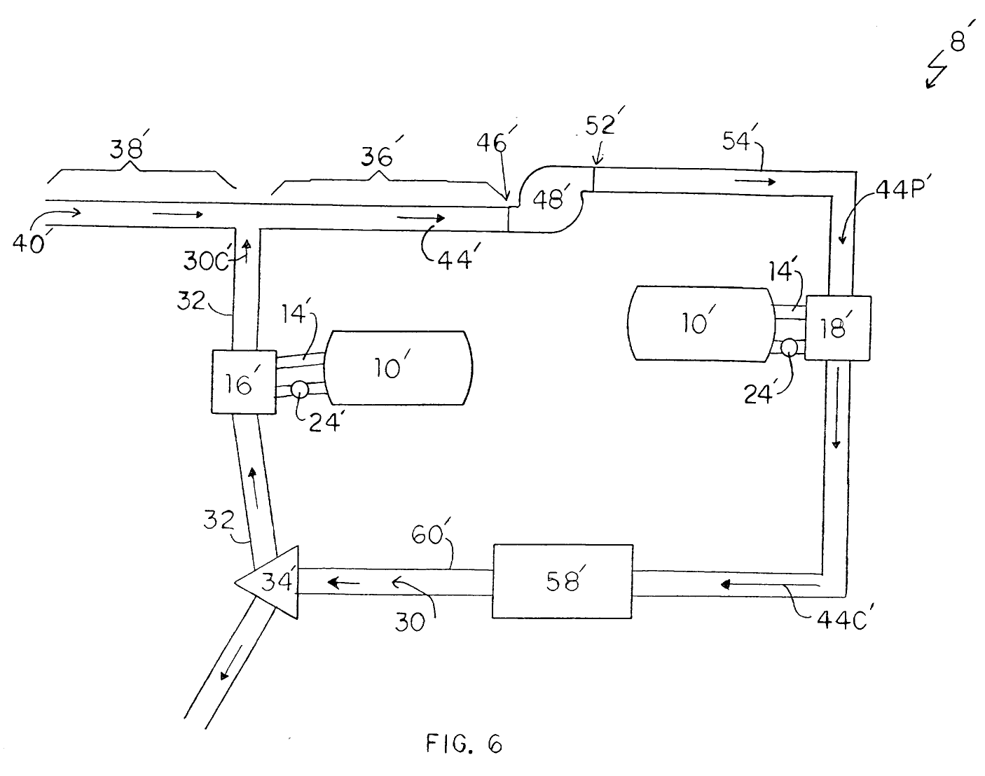

Referring to FIG. 5, a schematic of the thermoelectric heat exchanger is shown in relation to various elements. In operation, the cool fluid conduit 14 is in fluid communication with the cool fluid pump 24, the cool exhaust radiator 16 and the cool intake mixture radiator 18. In fluid communication with the warm fluid conduit are a warm fluid pump 76 and a hot side radiator 78. The cool fluid 20 is directed by the cool fluid pump 24 into thermal communication with the cooler surfaces 72 of the thermoelectric devices 22. As the temperature of the cool surfaces 72 is generally below that of the cool fluid 20, a thermal energy gradient exists thereby transferring thermal energy from the cool fluid 20 within the cool fluid conduit 14, through the second block of heat transfer material 70 and absorbed by the cooler surfaces 72 of the thermoelectric devices 22. The operation of the thermoelectric devices 22 for pumping thermal energy from the cooler surfaces 72 to the warmer surfaces 68 is well known in the art. As the thermal energy is pumped to the warmer surfaces 68, the warm fluid 80 is generally at a lower temperature than that of the warmer surface 68 of the thermoelectric device 22. Therefore, thermal energy transfers from the warmer surface 68 through the first block or third block of heat transfer material 66, 74 and is absorbed by the warm fluid 80 flowing through the warm fluid conduit 64. The exiting warm fluid 80 is directed to the hot side radiator 78, and the exiting cool fluid 20 is directed to the cool exhaust radiator 16 and the cool intake mixture radiator 18.

The cool fluid 20 outlet from the thermoelectric heat exchanger 10 includes a valve 86 that diverts a portion of the cool fluid through the cool exhaust radiator 16, with the remainder of the cool fluid flowing through the cool intake mixture radiator 18. The valve may be manually set or electronically controlled such that the proper proportion of cool fluid 20 flows through the respective radiators 16, 18. In each case, the fluid exiting the respective radiator 16, 18 is cycled via the cool fluid conduit 14 to the entrance of the thermoelectric heat exchanger 10.

The warm fluid pump 62 and the cool fluid pump 24 utilized in the present invention are variable speed centrifugal pumps. It is also within the scope of the present invention to utilize other types of pumps, for example, without limitation, positive displacement pumps. It is concurrently within the scope of the invention to utilize a fixed speed pump in conjunction with other flow governing means such as, without limitation, check and needle valves.

The hot side radiator 78 of this exemplary embodiment is a radiator with one or more convective devices 82 in proximity providing convective currents of ambient air should the location of the hot side radiator 78 be such that convective currents are necessitated or preferred for proper heat dissipation from the warm fluid 80. Such an exemplary location might be the back deck of an over the road truck. The convective devices are generally DC fans that are powered by the vehicle's power generation unit such as an alternator or battery. As the warm fluid 80 flows through the hot side radiator 78, convective currents of air draw off a portion of the thermal energy of the warm fluid 80, thereby cooling the warm fluid 80 before the warm fluid is directed back to the thermoelectric heat exchanger 10.

Referencing FIG. 6, a second exemplary embodiment of the invention is shown, wherein the cool exhaust radiator 16′ and the cool intake mixture radiator 18′ are in fluid communication with separate thermoelectric heat exchangers 10′. The manner in which the exhaust 30′ flows through the recycle exhaust conduit 32′, the cool exhaust 30C′ flows through the intake conduit 36′, the mixed fluid 44P′ flows through the mixed fluid conduit 54′, the mixed fluid 44P′ flows through intake mixture radiator 18′, and the cooled mixed fluid 44C′ flows through the exhaust conduit 60′ is analogous to that in the first exemplary embodiment.

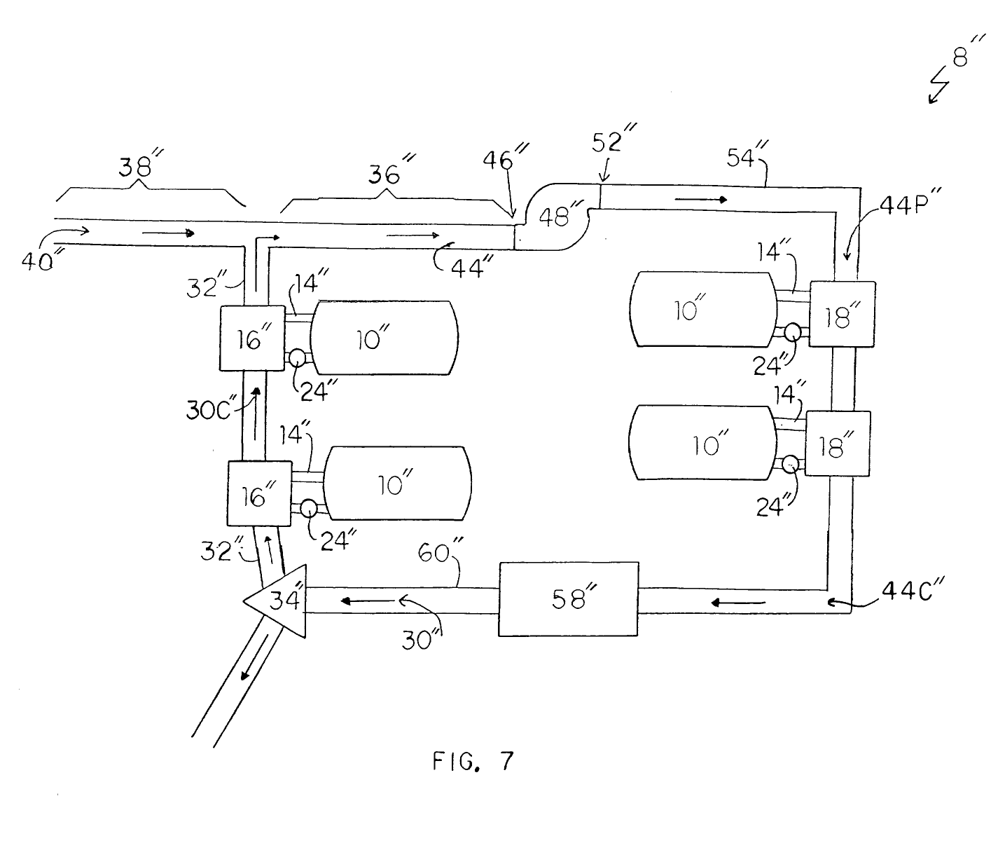

Referencing FIG. 7, a third exemplary embodiment of the invention is shown, wherein two cool exhaust radiators 16″ and two cool intake mixture radiators 18″ are in fluid communication with separate thermoelectric heat exchangers 10′. The manner in which the exhaust 30″ flows through the recycle exhaust conduit 32″, the cool exhaust 30C″ flows through the intake conduit 36″, the mixed fluid 44P″ flows through the mixed fluid conduit 54″, the mixed fluid 44P″ flows through intake mixture radiator 18″, and the cooled mixed fluid 44C″ flows through the exhaust conduit 60″ is analogous to that in the first exemplary embodiment. It is also within the scope of the invention to provide a radiator 16, 16′ or 16″ in fluid communication with the first feed 38, 38′ and 38″ and a thermoelectric heat exchanger 10, 10′ or 10″.

Exemplary control systems for diesel engines incorporating EGR are found in U.S. Pat. Nos. 6,422,219; 6,408,834; 6,401,700; 6,354,084; 6,128,902 to name a few. Such exemplary control systems may be configured by one of ordinary skill in the art to electronically monitor and control the present invention as well.

A first exemplary situation advantageous for such a control system may arise in cooler climates. In such a circumstance, it is advantageous for a limited amount of exhaust gas to be diverted into the recycle conduit. It is also advantageous for the exhaust gas, if any, be cooled to a lesser extent, but more importantly, for the air (or mixture if exhaust gas is diverted) not cooled to the maximum allowable by the invention such that the engine may warm up more quickly and reach a steady operating temperature more quickly.

A second exemplary situation advantageous for such a control system may arise in higher altitude climates. In such a circumstance, it is advantageous for a limited amount of exhaust gas to be diverted into the recycle conduit, thereby increasing the proportion of air to exhaust in the mixture to compensate for the concentration of oxygen at higher altitudes as opposed to sea level for example. In such a scenario in which the proportion of exhaust to air is decreased, so too is the heat load on the downstream side of the turbocharger. Put simply, the air coming into the intake will generally be at a significantly lower temperature than that of the cooled exhaust, therefore when the mixture is compressed by the turbocharger, a high proportion of air to exhaust results in mixture at a lower temperature downstream from the turbocharger as opposed to a higher proportion of exhaust to air which will typically result in a higher temperature mixture.

It is within the scope and spirit of the present invention to provide thermal communication between the internal combustion conduits carrying the air, air/exhaust mixture and exhaust and the cool fluid. An exemplary method may be accomplished by orienting the cool fluid conduits such as, without limitation, aluminum conduits thereby providing for thermal energy transfer between the cool fluid and the internal combustion conduits. In another exemplary embodiment, a cooling jacket provides throughput of the cooling fluid and is in fluid communication with one or more thermoelectric heat exchangers, thereby cooling the turbocharger. Cooling jackets for conduits are well known in the art.

While the aforementioned exemplary embodiments have utilized a contained heat transfer fluid to absorb thermal energy dissipated by the warmer surfaces of the thermoelectric devices, it is also within the scope and spirit of the present invention to provide an uncontained heat transfer fluid to carry away thermal energy dissipated by the warmer surfaces of the thermoelectric devices. Such an exemplary embodiment might utilize an electric fan to provide convective currents in proximity to the thermoelectric devices, thereby carrying away the thermal energy dissipated by the warmer surfaces of the thermoelectric devices. Additionally, a heat sink with a plurality of fins may also be used alone or in conjunction with any of the aforementioned devices for carrying away thermal energy.

The warm fluid and the cool fluid of the exemplary embodiment is generally any heat transfer fluid capable of absorbing thermal energy and dissipating thermal energy when thermal gradients present themselves. Among the exemplary fluids that may be utilized by the present invention are glycol mixtures, as well as specialized heat transfer fluids (depending upon the application and ambient conditions) such as, without limitation, Dow SYLTHERM 800, SYLTHERM XLT, SYLTHERM HF, DOWTHERM A, DOWTHERM J, DOWTHERM Q, DOWTHERM T, DOWTHERM SR-1, DOWFROST, DOWTHERM 4000, DOWFROST HD, DOWCAL N, DOWCAL 20, DOWCAL 10. Additionally, it is also within the scope and spirit of the present invention to utilize insulation to cover the piping carrying the cool fluid as well as the radiator in series with the conduits.

While the aforementioned embodiments have been explained with somewhat specific objectives (cooling exhaust, exhaust/air mixtures or air), other embodiments and modifications are intended to be covered by the spirit and scope of applicant's disclosure. It will be apparent to those of ordinary skill in the art that the above-mentioned exemplary embodiments may be configured in a plurality of different ways to bring about the heating and/or cooling of target fluids. The geometries of the conduits, the thermoelectric devices and the radiators are not of a unitary nature. Those of ordinary skill will appreciate that other geometries than those discussed above may be utilized in specific applications to reduce size, increase overall efficiency and/or reduce costs. Those of ordinary skill will also appreciate that each of the exemplary embodiments may be configured to heat a fluid by manipulating the conduits connected to the thermoelectric heat exchanger 10, or by inverting the direction of the electron flow to the thermoelectric devices 22. Also discernable to one of ordinary skill is the flexibility of utilizing a single thermoelectric device 22.

While the aforementioned exemplary embodiments have been described using a first, second and third blocks in thermal communication with the thermoelectric devices, it is also within the purview of this invention to refer to segments or portions of a single body of heat transfer material as being the first, second or third block. In such an application, the reference to two or more blocks is directed at describing the location of elevated thermal transfer through the heat transfer material and between a fluid and the surface of the thermoelectric device. In an exemplary application, a single piece of heat transfer material has an orientation (potentially U-shaped) to allow concurrent thermal communication between the first and third blocks of heat transfer material.

As a caveat to the heat transfer materials discussed above, it will be well understood by those skilled in the art that aluminum has a relatively high thermal conductivity (117 Btu/h·ft·° F. at 32° F.)) as compared to other metals such as mild steel (26 Btu/h·ft·° F. at 32° F.) and cast iron (30 Btu/h·ft·° F. at 68° F.). While aluminum's higher thermal conductivity makes it more advantageous to use as a material through which heat or thermal energy will travel, other materials could certainly be used such as cast iron, copper (224 Btu/h·ft·° F. at 32° F.), or more expensive materials such gold (169 Btu/h·ft·° F. at 68° F.) and silver (242 Btu/h·ft·° F. at 32° F.). For the purposes of this invention, therefore, a heat transfer material includes any material (metallic or non-metallic) having a suitable thermal conductivity for allowing heat transfer a warmer and cooler environment.

Following from the above description and invention summaries, it should be apparent to those of ordinary skill in the art that, while the methods and apparatuses herein described constitute exemplary embodiments of the present invention, it is to be understood that the inventions contained herein are not limited to these precise embodiments and that changes may be made to them without departing from the scope of the inventions as defined by the claims. Additionally, it is to be understood that the invention is defined by the claims and it not intended that any limitations or elements describing the exemplary embodiments set forth herein are to be incorporated into the meanings of the claims unless such limitations or elements are explicitly listed in the claims. Likewise, it is to be understood that it is not necessary to meet any or all of the identified advantages or objects of the invention disclosed herein in order to fall within the scope of any claims, since the invention is defined by the claims and since inherent and/or unforeseen advantages of the present invention may exist even though they may not have been explicitly discussed herein.

What is claimed is:

1. A fluid heat exchanger apparatus for cooling a fluid having an exhaust component associated with an internal combustion engine, the apparatus comprising:
at least one thermoelectric device, concurrently absorbing thermal energy on a cool side and dissipating thermal energy on a warm side;
a cool fluid conduit containing a cool fluid within a first closed loop, the cool fluid being in thermal communication with the cool side of at least the one thermoelectric device; and
a warm fluid conduit containing a warm fluid within a second closed loop, the warm fluid being in thermal communication with the warm side of at least the one thermoelectric device;
wherein the cool fluid conduit is positioned to be in thermal communication with an internal combustion engine fluid stream having an exhaust component, thereby cooling the internal combustion engine fluid stream having the exhaust component.

2. The apparatus of claim 1, further comprising:
a first cool fluid radiator operatively coupled to be in concurrent thermal communication with the cool fluid and the internal combustion engine fluid stream having the exhaust component, thereby cooling the internal combustion engine fluid stream having the exhaust component.

3. The apparatus of claim 2, further comprising:
a second cool fluid radiator in concurrent thermal communication with the cool fluid and the internal combustion engine fluid stream having the exhaust component, thereby cooling the internal combustion engine fluid stream having the exhaust component.

4. The apparatus of claim 3, wherein the second cool fluid radiator is downstream from a turbocharger.

5. The apparatus of claim 1, wherein the at least one thermoelectric device is electronically controlled.

6. A fluid heat exchanger apparatus for cooling a fluid having an exhaust component associated with an internal combustion engine, the apparatus comprising:
at least one thermoelectric device, concurrently absorbing thermal energy on a first surface and dissipating thermal energy on a second surface;
a closed cool fluid conduit having a cool fluid flowing therein with at least a portion of the cool fluid being in thermal communication with the first surface of the at least one thermoelectric device; and
an internal combustion conduit having a fluid stream flowing therein with an exhaust component;
wherein the fluid stream flowing within the internal combustion conduit comes into thermal communication with the cool fluid, thereby cooling the fluid stream.

7. The apparatus of claim 6, wherein the internal combustion conduit includes a turbocharger.

8. The apparatus of claim 6, further comprising a first block of heat transfer material in concurrent thermal communication with the first surface of the at least one thermoelectric device and the portion of the cool fluid.

9. The apparatus of claim 6, further comprising a convective device providing convective currents that absorb at least a portion of the thermal energy dissipated by the second surface of the at least one thermoelectric device.

10. The apparatus of claim 9, wherein the at least one thermoelectric device and the convective device are electronically controlled.

11. The apparatus of claim 9, further comprising a closed warm fluid conduit having a warm fluid flowing therein with at least a portion of the warm fluid being in thermal communication with the second surface of the at least one thermoelectric device.

12. The apparatus of claim 11, further comprising a second block of heat transfer material in concurrent thermal communication with the second surface of the at least one thermoelectric device and the portion of the warm fluid.

13. The apparatus of claim 11, further comprising a first radiator in concurrent fluid communication with the closed cool fluid conduit and the fluid stream, wherein the cool fluid is flowing through the first radiator and the fluid stream is flowing over the first radiator.

14. The apparatus of claim 13, wherein the first radiator is upstream from a turbocharger.

15. The apparatus of claim 13, wherein the first radiator is downstream from a turbocharger.

16. The apparatus of claim 13, further comprising a second radiator in concurrent fluid communication with the cool fluid conduit and the fluid stream, wherein the cool fluid is flowing through the second radiator and the fluid stream is flowing over the second radiator.

17. The apparatus of claim 16, wherein the first radiator is upstream from a turbocharger and the second radiator is downstream from the turbocharger.

18. The apparatus of claim 16, wherein the first radiator and second radiator are downstream from a turbocharger.

19. The apparatus of claim 16, wherein the first radiator and second radiator are upstream from a turbocharger.

20. The apparatus of claim 16, wherein:
the apparatus includes at least two of the thermoelectric devices;
a first thermoelectric heat exchanger includes a first of the two thermoelectric devices;
a second thermoelectric heat exchanger includes a second of the two thermoelectric devices;
the closed cool fluid conduit includes a first closed cool fluid conduit and a second closed cool fluid conduit;
the cool fluid includes a first cool fluid and a second cool fluid; and
the first cool fluid flows within the first closed cool fluid conduit and the second cool fluid flows within the second closed cool fluid conduit, and a portion of the first cool fluid is in thermal communication with the first surface of the first of the two thermoelectric devices and a portion of the second cool fluid is in thermal communication with the first surface of the second of the two thermoelectric devices.

21. A fluid heat exchanger apparatus for cooling a fluid having an exhaust component associated with an internal combustion engine, the apparatus comprising:
at least two thermoelectric devices, each thermoelectric device concurrently absorbing thermal energy on a first surface and dissipating thermal energy on a second surface;
a first closed cool fluid conduit having a first cool fluid flowing therein with at least a portion of the cool fluid being in thermal communication with the first surface of at least a first thermoelectric device;
a second closed cool fluid conduit having a second cool fluid flowing therein with at least a portion of the second cool fluid being in thermal communication with the first surface of at least a second thermoelectric device; and
an internal combustion conduit having a fluid stream flowing therein with an exhaust component;
wherein the fluid stream flowing within the internal combustion conduit comes into thermal communication with the first cool fluid and the second cool fluid, thereby cooling the fluid stream.

22. The apparatus of claim 21, wherein the at least two thermoelectric devices are electronically controlled.

23. The apparatus of claim 21, wherein the internal combustion conduit includes a turbocharger.

24. The apparatus of claim 21, further comprising:
a first block of heat transfer material in concurrent thermal communication with the first surface of the at least first thermoelectric device and the portion of the first cool fluid; and
a second block of heat transfer material in concurrent thermal communication with the first surface of the at least second thermoelectric device and the portion of the second cool fluid.

25. The apparatus of claim 24, further comprising a convective device providing convective currents absorbing at least a portion of the thermal energy dissipated by the second surface of the at least two thermoelectric devices.

26. The apparatus of claim 25, wherein the at least two thermoelectric devices and the convective device is electronically controlled.

27. The apparatus of claim 25, further comprising:
a first closed warm fluid conduit having a first warm fluid flowing therein with at least a portion of the first warm fluid being in thermal communication with the second surface of the at least first thermoelectric device; and
a second closed warm fluid conduit having a second warm fluid flowing therein with at least a portion of the second warm fluid being in thermal communication with the second surface of the at least second thermoelectric device.

28. The apparatus of claim 25, further comprising:
a closed warm fluid conduit having a warm fluid flowing therein with at least a portion of the warm fluid being in thermal communication with the second surface of the at least two thermoelectric devices.

29. The apparatus of claim 28, further comprising:
a first radiator in concurrent fluid communication with the first closed cool fluid conduit and the fluid stream, wherein the first cool fluid is flowing through the first radiator and the fluid stream is flowing over the first radiator; and
a second radiator in concurrent fluid communication with the second closed cool fluid conduit and the fluid stream, wherein the second cool fluid is flowing through the second radiator and the fluid stream is flowing over the second radiator.

30. The apparatus of claim 29, wherein the first radiator is upstream from a turbocharger and the second radiator is downstream from the turbocharger.

31. The apparatus of claim 29, wherein the first radiator and second radiator are downstream from a turbocharger.

32. The apparatus of claim 29, wherein the first radiator and second radiator are upstream from a turbocharger.

33. The apparatus of claim 28, wherein:
the closed warm fluid conduit includes a first closed warm fluid conduit and a second closed warm fluid conduit;
the warm fluid includes a first warm fluid and a second warm fluid; and
the first warm fluid flows within the first closed warm fluid conduit and the second warm fluid flows within the second closed warm fluid conduit, and a portion of the first warm fluid is in thermal communication with the second surface of the at least first thermoelectric device and a portion of the second warm fluid is in thermal communication with the second surface of the at least second thermoelectric device.

34. The apparatus of claim 33, further comprising:
a third block of heat transfer material in concurrent thermal communication with the second surface of the at least first thermoelectric device and the portion of the first warm fluid; and
a fourth block of heat transfer material in concurrent thermal communication with the second surface of the at least second thermoelectric device and the portion of the second warm fluid.

35. A fluid heat exchanger apparatus for cooling a fluid having an exhaust component associated with an internal combustion engine, the apparatus comprising:
at least one thermoelectric device concurrently absorbing thermal energy on a first surface and dissipating thermal energy on a second surface;
a closed cool fluid conduit having a cool fluid flowing therein with at least a portion of the cool fluid being in thermal communication with the first surface of the at least one thermoelectric device;
a closed warm fluid conduit having a warm fluid flowing therein with at least a portion of the warm fluid being in thermal communication with the second surface of the at least one thermoelectric device;
a first radiator in fluid communication with the closed cool fluid conduit;
a second radiator in fluid communication with the closed cool fluid conduit;
a third radiator in fluid communication with the closed warm fluid conduit;
a first internal combustion conduit section in fluid communication with the first radiator and having a first fluid stream with an exhaust component flowing therein;
a second internal combustion conduit section in fluid communication with the second radiator and having a second fluid stream with the exhaust component flowing therein;
a warm fluid pump directing the warm fluid throughout the closed warm fluid conduit; and
a cool fluid pump directing the cool fluid throughout the closed cool fluid conduit;
wherein the cool fluid flowing within the first radiator comes into thermal communication with the first fluid stream, thereby cooling the first fluid stream, and the cool fluid flowing through the second radiator comes into thermal communication with the second fluid stream, thereby cooling the second fluid stream.

36. The apparatus of claim 35, wherein the at least one thermoelectric device, the cool fluid pump and the warm fluid pump are electronically controlled.

37. The apparatus of claim 35, wherein:
the first radiator is in-line with the first internal combustion conduit section that is upstream from a turbocharger and; and
the second radiator is in-line with the second internal combustion conduit section that is downstream from the turbocharger.

38. The apparatus of claim 35, wherein the first radiator and the second radiator are in-line with the first internal combustion conduit section that is upstream from a turbocharger.

39. The apparatus of claim 35, further comprising a convective device providing convective currents absorbing at least a portion of the thermal energy dissipated by the second surface of the at least one thermoelectric device.

40. The apparatus of claim 35, wherein the first radiator and the second radiator are in-line with the second internal combustion conduit section that is downstream from a turbocharger.

41. The apparatus of claim 40, wherein the first fluid stream and the second fluid stream are the same stream.

42. The apparatus of claim 35, further comprising a diverter in series with the closed cool fluid conduit, wherein the diverter steers the cool fluid to the first and second radiator.

43. The apparatus of claim 42, wherein the diverter is electronically controlled so as to provide zero to 100 percent of the cool fluid flow to the first radiator.

44. A fluid heat exchanger apparatus for cooling a fluid having an exhaust component associated with an internal combustion engine, the apparatus comprising:
at least a first and a second thermoelectric device, each thermoelectric device concurrently absorbing thermal energy on a first surface and dissipating thermal energy on a second surface;
a first closed cool fluid conduit having a first cool fluid flowing therein with at least a portion of the cool fluid being in thermal communication with the first surface of the at least first thermoelectric device;
a second closed cool fluid conduit having a second cool fluid flowing therein with at least a portion of the second cool fluid being in thermal communication with the first surface of the at least second thermoelectric device;
a first closed warm fluid conduit having a first warm fluid flowing therein with at least a portion of the first warm fluid being in thermal communication with the second surface of the at least first thermoelectric device;
a second closed warm fluid conduit having a second warm fluid flowing therein with at least a portion of the second warm fluid being in thermal communication with the second surface of the at least second thermoelectric device;
a first radiator in fluid communication with the first closed cool fluid conduit;
a second radiator in fluid communication with the second closed cool fluid conduit;
a first radiator in fluid communication with the first closed warm fluid conduit;
a second radiator in fluid communication with the second closed cool fluid conduit;
a first cool fluid pump directing the first cool fluid throughout the first closed cool fluid conduit;
a second cool fluid pump directing the second cool fluid throughout the second closed cool fluid conduit;
a first warm fluid pump directing the first warm fluid throughout the first closed warm fluid conduit; and
a second warm fluid pump directing the second warm fluid throughout the second closed warm fluid conduit;
wherein the first cool fluid flowing within the first radiator comes into thermal communication with a first fluid stream having an exhaust component, thereby cooling the first fluid stream, and the second cool fluid flowing through the second radiator comes into thermal communication with a second fluid stream having the exhaust component, thereby cooling the second fluid stream.

45. The apparatus of claim 44, wherein the at least first and second thermoelectric devices, the first cool fluid pump, the second cool fluid pump, the first warm fluid pump and the second warm fluid pump are electronically controlled.

46. The apparatus of claim 44, further comprising:
a first internal combustion conduit section, in fluid communication with the first radiator, having the first fluid stream flowing therein with the exhaust component; and
a second internal combustion conduit section, in fluid communication with the second radiator, having the second fluid stream flowing therein with the exhaust component;
a first convective device providing convective currents absorbing at least a portion of the thermal energy dissipated by the second surface of the at least first thermoelectric device; and
a second convective device providing convective currents absorbing at least a portion of the thermal energy dissipated by the second surface of the at least second thermoelectric device.

47. The apparatus of claim 46, wherein the at least first and second thermoelectric devices, the first cool fluid pump, the second cool fluid pump, the first warm fluid pump, the second warm fluid pump, the first convective device and the second convective device are electronically controlled.

48. The apparatus of claim 44, wherein:
the first radiator is in-line with the first internal combustion conduit section that is upstream from a turbocharger; and
the second radiator is in-line with the second internal combustion conduit section that is downstream from the turbocharger.

49. The apparatus of claim 44, wherein the first radiator and the second radiator are in-line with the first internal combustion conduit section that is upstream from a turbocharger.

50. The apparatus of claim 49, wherein the first fluid stream and the second fluid stream are the same stream.

51. The apparatus of claim 44, wherein the first radiator and the second radiator are in-line with the second internal combustion conduit section that is downstream from a turbocharger.

52. The apparatus of claim 51, wherein the first fluid stream and the second fluid stream are the same stream.

53. A method of cooling a fluid having an exhaust component associated with an internal combustion engine, the method comprising the steps of:
activating at least one thermoelectric device, concurrently absorbing thermal energy on a cool side and dissipating thermal energy on a warm side;
orienting a cool fluid conduit containing a cool fluid within a first closed loop into thermal communication with the cool side of at least the one thermoelectric device;
orienting a warm fluid conduit containing a warm fluid within a second closed loop into thermal communication with the warm side of at least the one thermoelectric device; and
directing an internal combustion engine fluid stream having an exhaust component into thermal communication with the cool fluid, thereby cooling the internal combustion engine fluid stream having the exhaust component.

54. The method of claim 53, further comprising the step of:
orienting a first cool fluid radiator into concurrent thermal communication with the cool fluid and an internal combustion engine fluid stream having an exhaust component;
whereby the internal combustion engine fluid stream having the exhaust component is cooled by the cool fluid radiator.

55. The method of claim 54, further comprising the step of:
orienting a second cool fluid radiator in concurrent thermal communication with the cool fluid and the internal combustion engine fluid stream having the exhaust component;
whereby the internal combustion engine fluid stream having the exhaust component is cooled by the first and second cool fluid radiators.

56. The method of claim 55, wherein the second cool fluid radiator is downstream from a turbocharger.

57. The method of claim 53, further comprising the step of controlling electronically the at least one thermoelectric device.

58. A method of cooling a fluid having an exhaust component associated with an internal combustion engine, the method comprising the steps of:
activating at least one thermoelectric device, concurrently absorbing thermal energy on a first surface and dissipating thermal energy on a second surface;
orienting a closed cool fluid conduit having a cool fluid flowing therein, such that a portion of the cool fluid is in thermal communication with the first surface of the at least one thermoelectric device; and
orienting an internal combustion conduit having a fluid stream flowing therein with an exhaust component into thermal communication with the cool fluid;
whereby the fluid stream is cooled by the cool fluid.

59. The method of claim 58, wherein the internal combustion conduit includes a turbocharger.

60. The method of claim 58, further comprising the step of orienting a first block of heat transfer material into concurrent thermal communication with the first surface of the at least one thermoelectric device and the portion of the cool fluid.

61. The method of claim 58, further comprising the step of orienting a convective device providing convective currents such that the convective currents absorb at least a portion of the thermal energy dissipated by the second surface of the at least one thermoelectric device.

62. The method of claim 61, further comprising the step of controlling electronically the at least one thermoelectric device and the convective device.

63. The method of claim 61, further comprising the step of orienting a closed warm fluid conduit having a warm fluid flowing therein, such that a portion of the warm fluid is in thermal communication with the second surface of the at least one thermoelectric device.

64. The method of claim 63, further comprising the step of orienting a second block of heat transfer material into concurrent thermal communication with the second surface of the at least one thermoelectric device and the portion of the warm fluid.

65. The method of claim 63, further comprising the step of orienting a first radiator into concurrent fluid communication with the closed cool fluid conduit and the fluid stream, such that the cool fluid is flowing through the first radiator and the fluid stream is flowing over the first radiator.

66. The method of claim 65, wherein the first radiator is upstream from a turbocharger.

67. The method of claim 65, wherein the first radiator is downstream from a turbocharger.

68. The method of claim 65, further comprising the step of orienting a second radiator into concurrent fluid communication with the cool fluid conduit and the fluid stream, such that the cool fluid is flowing through the second radiator and the fluid stream is flowing over the second radiator.

69. The method of claim 68, wherein the first radiator is upstream from a turbocharger and the second radiator is downstream from the turbocharger.

70. The method of claim 68, wherein the first radiator and second radiator are downstream from a turbocharger.

71. The method of claim 68, wherein the first radiator and second radiator are upstream from a turbocharger.

72. The method of claim 68, wherein:
the apparatus includes at least two of the thermoelectric devices;
a first thermoelectric heat exchanger includes a first of the two thermoelectric devices;
a second thermoelectric heat exchanger includes a second of the two thermoelectric devices;
the closed cool fluid conduit includes a first closed cool fluid conduit and a second closed cool fluid conduit;
the cool fluid includes a first cool fluid and a second cool fluid; and
the first cool fluid flows within the first closed cool fluid conduit and the second cool fluid flows within the second closed cool fluid conduit, and a portion of the first cool fluid is in thermal communication with the first surface of the first of the two thermoelectric devices and a portion of the second cool fluid is in thermal communication with the first surface of the second of the two thermoelectric devices.

73. A method of cooling a fluid having an exhaust component associated with an internal combustion engine, the method comprising the steps of:
activating at least two thermoelectric devices, each thermoelectric device concurrently absorbing thermal energy on a first surface and dissipating thermal energy on a second surface;
orienting a first closed cool fluid conduit having a first cool fluid flowing therein, such that a portion of the first cool fluid is in thermal communication with the first surface of a first of the at least two thermoelectric devices;
orienting a second closed cool fluid conduit having a second cool fluid flowing therein, such that a portion of the second cool fluid is in thermal communication with the first surface of a second of the at least two thermoelectric devices; and
orienting an internal combustion conduit having a fluid stream flowing therein with an exhaust component;
whereby the fluid stream is cooled by the first cool fluid and the second cool fluid.

74. The method of claim 73, further comprising the step of controlling electronically the at least two thermoelectric devices.

75. The method of claim 73, wherein the internal combustion conduit includes a turbocharger.

76. The method of claim 73, further comprising the steps of:
orienting a first block of heat transfer material into concurrent thermal communication with the first surface of the first of the at least two thermoelectric device and the portion of the first cool fluid; and
orienting a second block of heat transfer material into concurrent thermal communication with the first surface of the second of the at least two thermoelectric devices and the portion of the second cool fluid.

77. The method of claim 73, further comprising the step of orienting a convective device providing convective currents such that the convective currents absorb at least a portion of the thermal energy dissipated by the second surface of at least the two thermoelectric devices.

78. The method of claim 77, further comprising the step of controlling electronically the at least two thermoelectric devices and the convective device.

79. The method of claim 77, further comprising the steps of:
orienting a first closed warm fluid conduit having a first warm fluid flowing therein, such that a portion of the first warm fluid is in thermal communication with the second surface of a first of the at least two thermoelectric devices; and
orienting a second closed warm fluid conduit having a second warm fluid flowing therein, such that a portion of the second warm fluid is in thermal communication with the second surface of a second of the at least two thermoelectric devices.

80. The method of claim 77, further comprising the step of orienting a closed warm fluid conduit having a warm fluid flowing therein, such that at least a portion of the warm fluid is in thermal communication with the second surface of at least the two thermoelectric devices.

81. The method of claim 80, further comprising the steps of:
orienting a first radiator into concurrent fluid communication with the first closed cool fluid conduit and the fluid stream, such that the first cool fluid is flowing through the first radiator and the fluid stream is flowing over the first radiator; and
orienting a second radiator into concurrent fluid communication with the second closed cool fluid conduit and the fluid stream, such that the second cool fluid is flowing through the second radiator and the fluid stream is flowing over the second radiator.

82. The method of claim 81, wherein the first radiator is upstream from a turbocharger and the second radiator is downstream from the turbocharger.

83. The method of claim 81, wherein the first radiator and second radiator are downstream from a turbocharger.

84. The method of claim 81, wherein the first radiator and second radiator are upstream from a turbocharger.

85. The method of claim 80, wherein:
the closed warm fluid conduit is comprised of a first closed warm fluid conduit and a second closed warm fluid conduit;
the warm fluid is comprised of a first warm fluid and a second warm fluid; and
the first warm fluid flows within the first closed warm fluid conduit and the second warm fluid flows within the second closed warm fluid conduit, and a portion of the first warm fluid is in thermal communication with the second surface of the first of the at least two thermoelectric devices and a portion of the second warm fluid is in thermal communication with the second surface of the second of the at least two thermoelectric devices.

86. The method of claim 85, further comprising the steps of:
orienting a third block of heat transfer material into concurrent thermal communication with the second surface of the first of the at least two thermoelectric devices and the portion of the first warm fluid; and
orienting a fourth block of heat transfer material into concurrent thermal communication with the second surface of the second of the at least two thermoelectric devices and the portion of the second warm fluid.

87. A method of cooling a fluid having an exhaust component associated with an internal combustion engine, the method comprising the steps of:
activating at least one thermoelectric device concurrently absorbing thermal energy on a first surface and dissipating thermal energy on a second surface;
orienting a closed cool fluid conduit having a cool fluid flowing therein with at least a portion of the cool fluid being in thermal communication with the first surface of the at least one thermoelectric device;
orienting a closed warm fluid conduit having a warm fluid flowing therein with at least a portion of the warm fluid being in thermal communication with the second surface of the at least one thermoelectric device;
orienting a first radiator into fluid communication with the closed cool fluid conduit;
orienting a second radiator into fluid communication with the closed cool fluid conduit;
orienting a third radiator into fluid communication with the closed warm fluid conduit;
orienting a first internal combustion conduit section into fluid communication with the first radiator and having a first fluid stream with an exhaust component flowing therein;
orienting a second internal combustion conduit section into fluid communication with the second radiator and having a second fluid stream with the exhaust component flowing therein;
orienting a warm fluid pump into fluid communication with the closed warm fluid conduit; and
orienting a cool fluid pump into fluid communication with the closed cool fluid conduit;
whereby the cool fluid flowing within the first radiator comes into thermal communication with the first fluid stream flowing, thereby cooling the first fluid stream, and the cool fluid flowing through the second radiator comes into thermal communication with the second fluid stream, thereby cooling the second fluid stream.

88. The method of claim 87, wherein the at least one thermoelectric device, the cool fluid pump and the warm fluid pump are electronically controlled.

89. The method of claim 87, wherein:
the first radiator is in-line with the first internal combustion conduit section that is upstream from a turbocharger and; and
the second radiator is in-line with the second internal combustion conduit section that is downstream from the turbocharger.

90. The method of claim 87, wherein the first radiator and the second radiator are in-line with the first internal combustion conduit section that is upstream from a turbocharger.

91. The method of claim 87, further comprising the step of orienting a convective device providing convective currents absorbing at least a portion of the thermal energy dissipated by the second surface of the at least one thermoelectric device.

92. The method of claim 87, wherein the first radiator and the second radiator are in-line with the second internal combustion conduit section that is downstream from a turbocharger.

93. The method of claim 92, wherein the first fluid stream and the second fluid stream are the same stream.

94. The method of claim 87, further comprising the step of orienting a diverter in series with the closed cool fluid conduit, wherein the diverter steers the cool fluid to the first and second radiator.

95. The method of claim 94, wherein the diverter is electronically controlled so as to provide zero to 100 percent of the cool fluid flow to the first radiator.

96. A method of cooling a fluid having an exhaust component associated with an internal combustion engine, the method comprising the steps of:
activating at least a first and a second thermoelectric device, each thermoelectric device concurrently absorbing thermal energy on a first surface and dissipating thermal energy on a second surface;
orienting a first closed cool fluid conduit having a first cool fluid flowing therein, a portion of the cool fluid being in thermal communication with the first surface of at least the first thermoelectric device;
orienting a second closed cool fluid conduit having a second cool fluid flowing therein, a portion of the second cool fluid being in thermal communication with the first surface of at least the second thermoelectric device;
orienting a first closed warm fluid conduit having a first warm fluid flowing therein, a portion of the first warm fluid being in thermal communication with the second surface of at least the first thermoelectric device;
orienting a second closed warm fluid conduit having a second warm fluid flowing therein, a portion of the second warm fluid being in thermal communication with the second surface of at least the second thermoelectric device;
orienting a first radiator into fluid communication with the first closed cool fluid conduit;
orienting a second radiator into fluid communication with the second closed cool fluid conduit;
orienting a first radiator into fluid communication with the first closed warm fluid conduit;
orienting a second radiator into fluid communication with the second closed cool fluid conduit;
orienting a first cool fluid pump into fluid communication with the first closed cool fluid conduit;
orienting a second cool fluid pump into fluid communication with the second closed cool fluid conduit;
orienting a first warm fluid pump into fluid communication the first closed warm fluid conduit; and
orienting a second warm fluid pump into fluid communication with the second closed warm fluid conduit;
whereby the first cool fluid flowing within the first radiator comes into thermal communication with a first fluid stream having an exhaust component, thereby cooling the first fluid stream, and the second cool fluid flowing through the second radiator comes into thermal communication with a second fluid stream having the exhaust component, thereby cooling the second fluid stream.

97. The method of claim 96, wherein the at least first and second thermoelectric device, the first cool fluid pump, the second cool fluid pump, the first warm fluid pump and the second warm fluid pump are electronically controlled.

98. The method of claim 96, further comprising the steps of:
orienting a first internal combustion conduit section into fluid communication with the first radiator, having the first fluid stream flowing therein with the exhaust component;
orienting a second internal combustion conduit section into fluid communication with the second radiator, having the second fluid stream flowing therein with the exhaust component;
orienting a first convective device providing convective currents absorbing at least a portion of the thermal energy dissipated by the second surface of the at least first thermoelectric device; and
orienting a second convective device providing convective currents absorbing at least a portion of the thermal energy dissipated by the second surface of the at least second thermoelectric device.

99. The method of claim 98, wherein the at least first and second thermoelectric devices, the first cool fluid pump, the second cool fluid pump, the first warm fluid pump, the second warm fluid pump, the first convective device and the second convective device are electronically controlled.

100. The method of claim 96, wherein:
the first radiator is in-line with the first internal combustion conduit section that is upstream from a turbocharger; and
the second radiator is in-line with the second internal combustion conduit section that is downstream from the turbocharger.

101. The method of claim 96, wherein the first radiator and the second radiator are in-line with the first internal combustion conduit section that is upstream from a turbocharger.

102. The method of claim 101, wherein the first fluid stream and the second fluid stream are the same stream.

103. The method of claim 96, wherein the first radiator and the second radiator are in-line with the second internal combustion conduit section that is downstream from a turbocharger.

104. The method of claim 103, wherein the first fluid stream and the second fluid stream are the same stream.

105. An exhaust gas recirculation system for a vehicle comprising:
an internal combustion engine having a gas intake and an exhaust outlet;
a turbocharger having a gas intake and a pressurized gas outlet;
a turbo fluid conduit providing fluid communication between the pressurized gas outlet of the turbocharger and the gas intake of the internal combustion engine;
an exhaust recirculation conduit providing fluid communication between the exhaust outlet of the internal combustion engine and the gas intake of the turbocharger; and
a first heat exchanger generating a thermal gradient between (a) fluid flow in at least one of the turbo fluid conduit and the exhaust recirculation conduit and (b) at least one Peltier-effect thermoelectric device concurrently dissipating thermal energy on a warm surface thereof and absorbing thermal energy on a cool surface thereof.

106. The exhaust recirculation system of claim 105, wherein the first heat exchanger generates a thermal gradient between the fluid flow in the turbo fluid conduit and the cool surface of the Peltier-effect thermoelectric device.

107. The exhaust recirculation system of claim 106, wherein the first heat exchanger includes a first radiator positioned in the fluid flow of the turbo fluid conduit.

108. The exhaust recirculation system of claim 107, wherein the first radiator receives a recirculated liquid cooled by the Peltier-effect thermoelectric device of the first heat exchanger.

109. The exhaust recirculation system of claim 105, wherein the first heat exchanger generates a thermal gradient between the fluid flow in the exhaust recirculation conduit and the cool surface of the Peltier-effect thermoelectric device.

110. The exhaust recirculation system of claim 109, wherein the first heat exchanger includes a first radiator positioned in the fluid flow of the exhaust recirculation conduit.

111. The exhaust recirculation system of claim 110, wherein the first radiator receives a recirculated liquid cooled by the Peltier-effect thermoelectric device of the first heat exchanger.

112. An exhaust gas recirculation system for a vehicle comprising:
an internal combustion engine having a gas intake and an exhaust outlet;
a turbocharger having a gas intake and a pressurized gas outlet;
a turbo fluid conduit providing fluid communication between the pressurized gas outlet of the turbocharger and the gas intake of the internal combustion engine;
an exhaust recirculation conduit providing fluid communication between the exhaust outlet of the internal combustion engine and the gas intake of the turbocharger;
a first heat exchanger generating a thermal gradient between fluid flow in the turbo fluid conduit and at least one Peltier-effect thermoelectric device concurrently dissipating thermal energy on a warm surface thereof and absorbing thermal energy on a cool surface thereof; and
a second heat exchanger generating a thermal gradient between fluid flow in the exhaust recirculation conduit and at least one Peltier-effect thermoelectric device concurrently dissipating thermal energy on a warm surface thereof and absorbing thermal energy on a cool surface thereof.

113. The exhaust recirculation system of claim 112, wherein the first heat exchanger generates a thermal gradient between the fluid flow in the turbo fluid conduit and the cool surface of the respective Peltier-effect thermoelectric device and the second heat exchanger generates a thermal gradient between the fluid flow in the exhaust recirculation conduit and the cool surface of the respective Peltier-effect thermoelectric device.

114. The exhaust recirculation system of claim 113, wherein the first and second heat exchangers include first and second radiators respectively positioned in the fluid flows of the turbo fluid conduit and the exhaust recirculation conduit.

115. The exhaust recirculation system of claim 114, wherein the first and second radiators receive a recirculated liquid cooled by respective Peltier-effect thermoelectric devices of the first and second heat exchangers.

116. The exhaust recirculation system of claim 115, wherein the first and second heat exchangers utilize the same Peltier-effect thermoelectric device to cool the liquid recirculated through the first and second radiators.

117. The exhaust recirculation system of claim 115, wherein the first and second heat exchangers respectively utilize first and second Peltier-effect thermoelectric devices to respectively cool the liquid recirculated through the first and second radiators.

118. A method of cooling an exhaust gas recirculation system for a vehicle, the gas recirculation system including a turbo fluid conduit to providing fluid communication between a pressurized gas outlet of a turbocharger and a gas intake of an internal combustion engine, and including an exhaust recirculation conduit to provide fluid communication between an exhaust outlet of the internal combustion engine and a gas intake of the turbocharger, the method comprising the step of:
orienting a first heat exchanger so as to generate a thermal gradient between fluid flow in at least one of the turbo fluid conduit and the exhaust recirculation conduit and at least one Peltier-effect thermoelectric device concurrently dissipating thermal energy on a warm surface thereof and absorbing thermal energy on a cool surface thereof.

119. The method of claim 118, wherein the first heat exchanger generates a thermal gradient between the fluid flow in the turbo fluid conduit and the cool surface of the Peltier-effect thermoelectric device.

120. The method of claim 119, wherein the first heat exchanger includes a first radiator respectively positioned in the fluid flow of the turbo fluid conduit.

121. The method of claim 120, further comprising the step of recirculating a liquid cooled by respective Peltier-effect thermoelectric devices of the first heat exchanger through the first radiator.

122. The method of claim 121, wherein the first heat exchanger generates a thermal gradient between the fluid flow in the exhaust recirculation conduit and the cool surface of the Peltier-effect thermoelectric device.

123. The method of claim 122, wherein the first heat exchanger includes a first radiator positioned in the fluid flows of the exhaust recirculation conduit.

124. The exhaust recirculation system of claim 123, further comprising the step of recirculating a liquid cooled by the Peltier-effect thermoelectric device of the first heat exchanger through the first radiator.

125. The method of claim 124, wherein the first and second heat exchangers respectively utilize first and second Peltier-effect thermoelectric devices to respectively cool the liquid recirculated through the first and second radiators.

126. A method of cooling an exhaust gas recirculation system for a vehicle, the exhaust gas recirculating system including a turbo fluid conduit providing fluid communication between a pressurized gas outlet of a turbocharger and a gas intake of the internal combustion engine, and including an exhaust recirculation conduit providing fluid communication between an exhaust outlet of the internal combustion engine and a gas intake of the turbocharger, the method comprising the step of:
generating a thermal gradient between fluid flow in the turbo fluid conduit and at least one Peltier-effect thermoelectric device concurrently dissipating thermal energy on a warm surface thereof and absorbing thermal energy on a cool surface thereof, with a first heat exchanger; and
generating a thermal gradient between fluid flow in the exhaust recirculation conduit and at least one Peltier-effect thermoelectric device concurrently dissipating thermal energy on a warm surface thereof and absorbing thermal energy on a cool surface thereof, with a second heat exchanger.

127. The method of claim 126, wherein:
the first heat exchanger generates a thermal gradient between the fluid flow in the turbo fluid conduit and the cool surface of the respective Peltier-effect thermoelectric device; and
the second heat exchanger generates a thermal gradient between the fluid flow in the exhaust recirculation conduit and the cool surface of the respective Peltier-effect thermoelectric device.

128. The method of claim 127, wherein the first and second heat exchangers include first and second radiators respectively positioned in the fluid flows of the turbo fluid conduit and the exhaust recirculation conduit.

129. The method of claim 128, further comprising the step of recirculating liquid cooled by respective Peltier-effect thermoelectric devices of the first and second heat exchangers respectively through the first and second radiators.

130. The method of claim 129, wherein the first and second heat exchangers utilize the same Peltier-effect thermoelectric device to cool the liquid recirculated through the first and second radiators.

131. The method of claim 129, wherein the first and second heat exchangers respectively utilize first and second Peltier-effect thermoelectric devices to respectively cool the liquid recirculated through the first and second radiators.
